(19) United States
(12) Patent Application Publication
(10) Pub. No.: US 2025/0350077 A1
(43) Pub. Date: Nov. 13, 2025

(54) ELECTRICAL CONNECTOR AND DC BUSWAY

(71) Applicant: Schneider Electric Industries SAS, Rueil Malmaison (FR)

(72) Inventors: Xianfeng Song, Guangzhou (CN); Tianjin Xiao, Guangzhou (CN); Jianyuan Huang, Guangzhou (CN); Lieyan Bai, Guangzhou (CN)

(73) Assignee: Schneider Electric Industries SAS, Rueil Malmaison (FR)

(21) Appl. No.: 19/203,545

(22) Filed: May 9, 2025

(30) Foreign Application Priority Data
May 11, 2024 (CN) 2024210214538

(51) Int. Cl. H01R 25/14

(52) U.S. Cl. CPC H01R 25/145

(57) ABSTRACT

Embodiments of the present disclosure provide an electrical connector and a DC busway, the electrical connector comprising a pair of conductors; a first insulating assembly disposed between the pair of conductors; and a pair of second insulating assemblies each disposed on a side of the pair of conductors facing away from the first insulating assembly; wherein each of the pair of conductors is integrally formed, or each of the pair of conductors comprises at least one pair of conductive parts.

### CROSS-REFERENCE

The present application claims priority to Chinese Utility Model Patent Application No. 202421021453.8, filed on May 11, 2024, and entitled “ELECTRICAL CONNECTOR AND DC BUSWAY”, which is incorporated herein by reference in its entirety.

### FIELD

Embodiments of the present disclosure generally relate to the technical field of electrical equipment, and more particularly, to an electrical connector and a DC busway.

### BACKGROUND

A conventional busway is usually applied to an AC scenario, and if the busway is applied to a DC scenario, one of the solutions is that a phase A busbar and a phase B busbar need to be connected in parallel to form a pole, and a phase C busbar and a neutral busbar are connected in parallel to form another pole.

In order to apply an AC busway to the DC scenario, a conventional DC busway is usually provided with flanges at both ends of its loop. However, in a case of taking power from a plug interface position in a middle of the loop to supply power to loads such as a plug-in box, it is easy to cause the loads or currents of a same-pole busbar downstream of the loop to be unbalanced.

### SUMMARY

An object of the present disclosure is to provide an electrical connector and a DC busway to at least partially solve the above problems.

In a first aspect of the present disclosure, there is provided an electrical connector comprising a pair of conductors; a first insulating assembly disposed between the pair of conductors; and a pair of second insulating assemblies each disposed on a side of the pair of conductors facing away from the first insulating assembly; wherein each of the pair of conductors is integrally formed, or each of the pair of conductors comprises at least one pair of conductive parts.

According to embodiments of the present disclosure, the conductor is integrally formed or comprises the at least one pair of conductive parts, in a case that one busbar in a same-pole busbar is in contact with a side of the conductor, and the other busbar in the same-pole busbar is in contact with the other side of the conductor, since the conductor can conduct busbars on both sides, the same-pole busbar can be connected in parallel again at a position of the electrical connector through the conductor. That is, the electrical connector can achieve a current-converging effect, thereby solving a problem that loads or currents of the same-pole busbar downstream of the loop are unbalanced.

In some embodiments, each of the pair of conductors comprises a pair of conductive parts arranged along a first direction and detachably connected to each other.

In some embodiments, surfaces of the pair of conductive parts adjacent to each other are planes.

In some embodiments, each of the pair of conductive parts comprises grooves disposed on surfaces of the pair of conductive parts adjacent to each other.

In some embodiments, the grooves of each of the pair of conductive parts are spaced apart from each other.

In some embodiments, the grooves of each of the pair of conductive parts extend along a second direction perpendicular to the first direction.

In some embodiments, the grooves in the pair of conductive parts are aligned with each other, or the grooves in the pair of conductive parts are staggered from each other.

In some embodiments, the at least one pair of conductive parts are arranged along a first direction, the electrical connector further comprises a pair of installation parts each disposed within an installation hole of a corresponding conductor, and along the first direction, one end of each of the pair of installation parts is matched with a corresponding first insulating assembly, and the other end of each of the pair of installation parts is matched with a corresponding second insulating assembly.

In a second aspect of the present disclosure, there is provided a DC busway, comprising: any electrical connector according to the first aspect of the present disclosure; and a basic segment.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 shows a cross-sectional view of an electrical connector according to some embodiments of the present disclosure;

FIG. 2 shows an exploded view of an electrical connector according to some embodiments of the present disclosure;

FIG. 3 shows a schematic structural diagram of a conductor according to some embodiments of the present disclosure;

FIGS. 4 to 7 show schematic structural diagrams of conductors according to some other embodiments of the present disclosure;

FIG. 8 shows a partial structural schematic diagram of a DC busway according to some embodiments of the present disclosure;

FIG. 9 shows a front view of the DC busway shown in FIG. 8.

### LIST OF REFERENCE SYMBOLS

100 is an electrical connector, 10 is a conductor, 20 is a first insulating assembly, 21 is a first insulating plate, 22 is a first conductive plate, 30 is a second insulating assembly, 31 is a second insulating plate, 32 is a second conductive plate, 40 is an upper cover, 50 is a lower cover, 60 is an installation part; 200 is a basic segment, 201 is a first phase busbar, 202 is a second phase busbar, 203 is a third phase busbar, 204 is a neutral busbar, and 205 is a ground busbar;
1 is a conductive part, 11 is a groove, 12 is a installation hole, and 13 is a guide slope;
X is a first direction, and Y is a second direction.

### DETAILED DESCRIPTION

Embodiments of the present disclosure will be described in more detail below with reference to the accompanying drawings. While the embodiments of the present disclosure are shown in the drawings, it should be understood that the present disclosure may be implemented in various forms and should not be limited by the embodiments set forth herein. Rather, these embodiments are provided to make this disclosure more thorough and complete, and to fully convey the scope of the present disclosure to those skilled in the art.

As used herein, the term “comprising” and variations thereof represent openness, i.e., “including but not limited to”. Unless specifically stated, the term “or” means “and/or”. The term “based on” means “based at least in part on”. The terms “an example embodiment” and “an embodiment” mean “at least one example embodiment”. The term “another embodiment” means “at least one further embodiment”. The terms “first,” “second,” and the like may refer to different or identical objects.

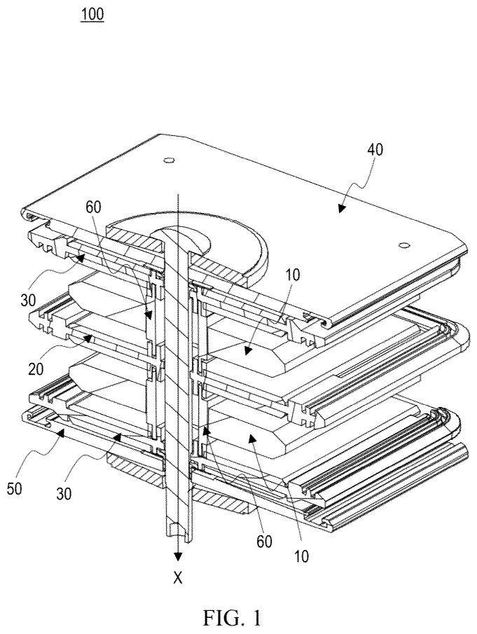

As described above, a conventional DC busway is usually provided with flanges at both ends of its loop, so as to connect a phase A busbar and a phase B busbar in parallel and connect a phase C busbar and a neutral busbar in parallel. However, in a case of taking power from a plug interface position in a middle of the loop to supply power to loads such as a plug-in box, the loads or currents of a same-pole busbar downstream of the loop are unbalanced due to a difference in lengths of conductors of the same-pole busbar, a difference of contact resistance during connection of an electrical connector, and a difference in lengths of electrical loops of plug-in boxes. Embodiments of the present disclosure provide an electrical connector 100 and a DC busway to at least partially solve the above problems. Hereinafter, the principles of the present disclosure will be described with reference to FIGS. 1 to 9.

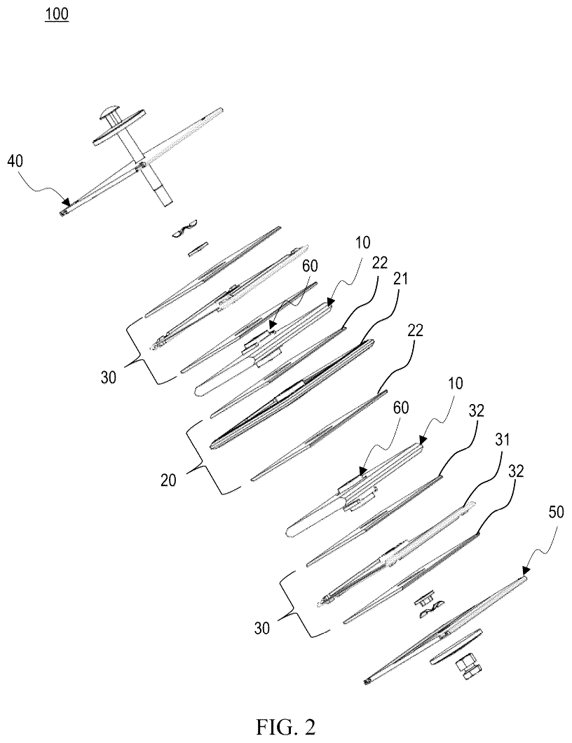

FIG. 1 shows a cross-sectional view of an electrical connector 100 according to some embodiments of the present disclosure. FIG. 2 shows an exploded view of an electrical connector 100 according to some embodiments of the present disclosure. As shown in FIGS. 1 and 2, the electrical connector 100 described herein generally includes a pair of conductors 10, a first insulating assembly 20, a pair of second insulating assemblies 30, an upper cover 40, a lower cover 50, and a pair of installation parts 60.

With continued reference to FIGS. 1-2, the first insulating assembly 20 is disposed between the pair of conductors 10. Each of the pair of second insulating assemblies 30 is disposed on a side of the pair of conductors 10 facing away from the first insulating assembly 20. It can be understood that along a first direction X, the upper cover 40, one of the pair of second insulating assemblies 30, one of the pair of conductors 10, the first insulating assembly 20, the other one of the pair of conductors 10, the other one of the pair of second insulating assemblies 30 and the lower cover 50 are sequentially arranged. A bolt may pass through a bolt shim, the upper cover 40, the pair of conductors 10, the first insulating assembly 20, the pair of second insulating assemblies 30, the lower cover 50 and a nut shim, and the bolt may be locked by a nut.

FIG. 3 shows a schematic structural diagram of a conductor 10 according to some embodiments of the present disclosure. As shown in FIG. 3, each of the pair of conductors 10 is integrally formed. Whereby, the conductor 10 according to the embodiment of the present disclosure can cancel a design of a middle insulating part, allowing the conductor 10 to conduct busbars on both sides without changing a size of the conductor 10. Meanwhile, since the conductor 10 cancels the design of the middle insulating part, the heat conduction performance of the electrical connector 100 is improved, thereby significantly reducing temperature rise at the electrical connector 100.

With the above configuration, in a case that one busbar in the same-pole busbar is in contact with a side of the conductor 10 and the other busbar in the same-pole busbar is in contact with the other side of the conductor 10, since the conductor 10 can conduct the busbars on both sides, the same-pole busbar can be connected in parallel again at a position of the electrical connector 100 through the conductor 10. That is, the electrical connector 100 can achieve a current-converging effect, thereby solving the problem that the loads or the currents of the same-pole busbar downstream of the loop are unbalanced.

Further, with continued reference to FIGS. 1 to 3, each of the pair of conductors 10 may include an installation hole 12. Each of the pair of installation parts 60 may be disposed within the installation hole 12 of a corresponding conductor 10. Along the first direction X, one end of each of the pair of installation parts 60 may be matched with a corresponding first insulating assembly 20, and the other end of each of the pair of installation parts 60 may be matched with a corresponding second insulating assembly 30.

Further, with continued reference to FIGS. 1 to 3, each of the pair of conductors 10 may include guide slopes 13. The guide slopes 13 may extend along a second direction Y. The second direction Y may be perpendicular to the first direction X. The guide slopes 13 may be located at an edge position of the conductor 10. It can be understood that the guide slopes 13 can achieve a guiding effect, thereby facilitating insertion of the busbar.

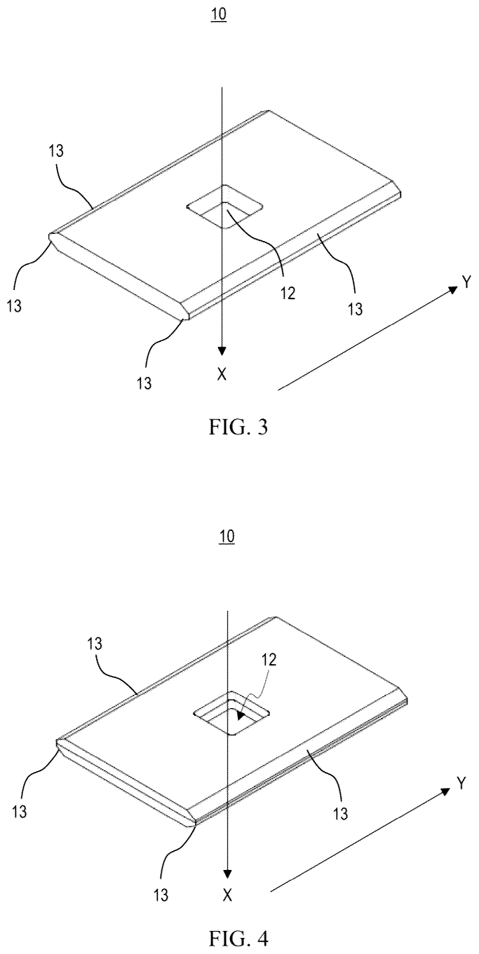

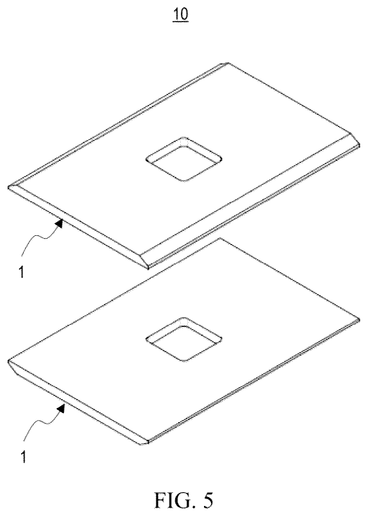

FIGS. 4 to 7 show schematic structural diagrams of conductors 10 according to some other embodiments of the present disclosure. The conductors 10 shown in FIGS. 4 to 7 have similar structures to the conductor 10 shown in FIG. 3, such as an installation hole 12 and guide slopes 13, but are not limited thereto. The difference is primarily that the conductors 10 shown in FIGS. 4 to 7 may include at least one pair of conductive parts 1. Hereinafter, the difference between the two will be mainly described, and the same part will not be repeated.

Referring to FIGS. 4 to 7, in some embodiments, each of the pair of conductors 10 includes the at least one pair of conductive parts 1. Whereby, the conductor 10 according to the embodiments of the present disclosure can cancel the design of the middle insulating part, allowing the conductor 10 to conduct the busbars on both sides without changing the size of the conductor 10. Meanwhile, since the conductor 10 cancels the design of the middle insulating part, the heat conduction performance of the electrical connector 100 is improved, thereby significantly reducing temperature rise at the electrical connector 100.

With the above configuration, the conductor 10 includes the at least one pair of conductive parts 1, in a case that the one busbar in the same-pole busbar is in contact with a side of the conductor 10 and the other busbar in the same-pole busbar is in contact with the other side of the conductor 10, since the conductor 10 can conduct the busbars on both sides, the same-pole busbar can be connected in parallel again at the position of the electrical connector 100 through the conductor 10. That is, the electrical connector 100 can achieve the current-converging effect, thereby solving the problem that the loads or the currents of the same-pole busbar downstream of the loop are unbalanced.

Further, with continued reference to FIGS. 4 to 7, the at least one pair of conductive parts 1 may be arranged along the first direction X, and adjacent conductive parts 1 of the at least one pair of conductive parts 1 are connected to each other.

It should be noted that the numbers, values, quantities, etc., which may be mentioned above and elsewhere in the present disclosure, are exemplary and are not intended to limit the scope of the present disclosure in any way. Any other suitable number, values, quantities are possible.

For example, with continued reference to FIGS. 4 to 7, in some embodiments, each of the pair of conductors 10 may include a pair of conductive parts 1. The pair of conductive parts 1 may be arranged along the first direction X, and the pair of conductive parts 1 are detachably connected to each other.

Hereinafter, the structure of the conductor 10 of the embodiment of the present disclosure will be described mainly by taking an example that each of the pair of conductors 10 includes the pair of conductive parts 1 and the pair of conductive parts 1 may be detachably connected to each other. The case that each of the pair of conductors 10 includes three or more conductive parts 1 is similar, and will not be repeated here.

With the above configuration, in a case that the one busbar in the same-pole busbar is in contact with one of the pair of conductive parts 1, and the other busbar in the same-pole busbar is in contact with the other one of the pair of conductive parts 1, since the pair of conductive parts 1 are connected, the same-pole busbar can be connected in parallel again at the position of the electrical connector 100 through the conductor 10. That is, the electrical connector 100 can achieve the current-converging effect, thereby solving the problem that the loads or the currents of the same-pole busbar downstream of the loop are unbalanced.

Referring to FIGS. 4 and 5, in some embodiments, surfaces of the pair of conductive parts 1 adjacent to each other may be planes. Whereby, the pair of conductive parts 1 are convenient to be mounted, and a production cost is reduced.

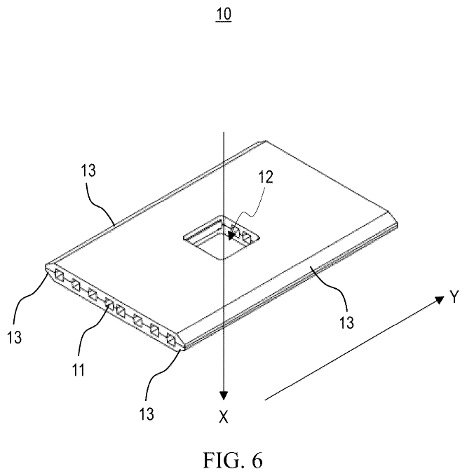

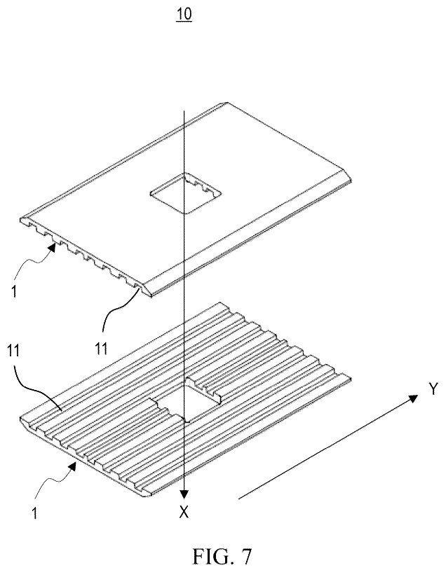

Referring to FIGS. 6 and 7, in some embodiments, each of the pair of conductive parts 1 includes grooves 11. The grooves 11 may be disposed on surfaces of the pair of conductive parts 1 adjacent to each other. Of course, if the surfaces of the pair of conductive parts 1 adjacent to each other may be the planes, the grooves 11 may be disposed on the planes. It can be understood that the groove 11 is opened, which is beneficial to reducing a material of the conductive part 1, thereby reducing the production cost of the conductor 10.

Further, referring to FIG. 7, the grooves 11 of each of the pair of conductive parts 1 may be spaced apart from each other.

Further, with continued reference to FIG. 7, the groove 11 of each of the pair of conductive parts 1 may extend along the second direction Y perpendicular to the first direction X.

Further, with continued reference to FIGS. 6 and 7, the grooves 11 in the pair of conductive parts 1 may be aligned with each other. Of course, the grooves 11 in the pair of conductive parts 1 may also be staggered from each other.

Referring back to FIGS. 4 to 7, in some embodiments, in a case that each of the pair of conductors 10 includes the installation hole 12, one of the pair of conductive parts 1 may include a portion of the installation hole 12, and then the other conductive part 1 may include the other portion of the installation hole 12. It can be understood that the installation hole 12 of the conductor 10 is formed in a case of connecting the pair of conductive parts 1 to form the conductor 10.

Referring back to FIGS. 4 to 7, in some embodiments, in a case that each of the pair of conductors 10 includes the guide slopes 13, the guide slopes 13 may be disposed on the pair of conductive parts 1, and the guide slopes 13 may be located at an edge position of the conductive part 1 to facilitate insertion of the busbar.

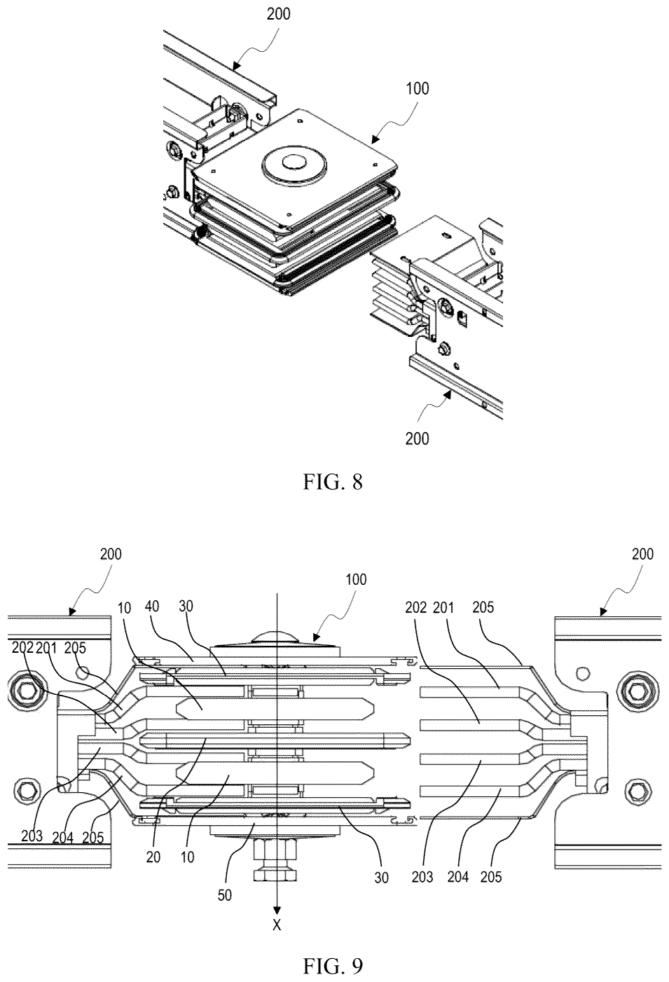

FIG. 8 shows a partial structural schematic diagram of a DC busway according to some embodiments of the present disclosure. FIG. 9 shows a front view of the DC busway shown in FIG. 8. As shown in FIGS. 8 and 9, an embodiment of the present disclosure further provides the DC busway including any electrical connector 100 as described above and basic segments 200. The electrical connector 100 is located between adjacent basic segments 200.

With continued reference to FIGS. 8 and 9, each basic segment 200 may include a first phase busbar 201, a second phase busbar 202, a third phase busbar 203, a neutral busbar 204, and a pair of ground busbars 205. One of the pair of ground busbars 205 is located between the upper cover 40 and a corresponding second insulating assembly 30, and the other ground busbar 205 is located between the lower cover 50 and a corresponding second insulating assembly 30. The first phase busbar 201 is located between an upper second insulating assembly 30 and an upper conductor 10. The neutral busbar 204 is located between a lower second insulating assembly 30 and a lower conductor 10. The second phase busbar 202 is located between the first insulating assembly 20 and the upper conductor 10. The third phase busbar 203 is located between the first insulating assembly 20 and the lower conductor 10.

It can be seen that the first phase busbar 201 and the second phase busbar 202 can be connected in parallel through a corresponding conductor 10, and the third phase busbar 203 and the neutral busbar 204 can be connected in parallel through a corresponding conductor 10.

It should be noted that referring back to FIG. 2, in some embodiments, the first insulating assembly 20 may include a first insulating plate 21 and a pair of first conductive plates 22. One of the pair of first conductive plates 22 is disposed on a side of the first insulating plate 21, and the other one of the pair of first conductive plates 22 is disposed on an opposite side of the first insulating plate 21 along the first direction X. The first insulating plate 21 is clamped between the pair of first conductive plates 22 and can prevent the pair of first conductive plates 22 from being conducted.

It can be understood that, referring to FIGS. 2 and 9, the first insulating assembly 20 can prevent the second phase busbar 202 and the third phase busbar 203 from being conducted through the first insulating plate 21, so as to achieve an insulation effect. However, due to the presence of the pair of first conductive plates 22, the same busbar of the adjacent basic segments 200 can be conducted (e.g., the second phase busbar 202 of the adjacent basic segments 200 are conducted).

Referring back to FIG. 2, in some embodiments, each of the pair of second insulating assemblies 30 may include a second insulating plate 31 and a pair of second conductive plates 32. One of the pair of second conductive plates 32 is disposed on a side of the second insulating plate 31, and the other one of the pair of second conductive plates 32 is disposed on an opposite side of the second insulating plate 31 along the first direction X. The second insulating plate 31 is clamped between the pair of second conductive plates 32 and can prevent the second conductive plate 32 from being conducted.

Similarly, referring to FIGS. 2 and 9, on the basis that the second insulating assembly 30 can prevent the ground busbar 205 and the first phase busbar 201 from being conducted through the second insulating plate 31, the ground busbar 205 and the fourth phase busbar 204 can be prevented from being conducted, so as to achieve the insulation effect. However, due to the presence of the pair of second conductive plates 32, the same busbar of the adjacent basic segments 200 can be conducted (e.g., the ground busbar 205 of the adjacent basic segments 200 are conducted).

The electrical connector 100 according to the embodiments of the present disclosure may be applied to various DC busways to at least partially solve the above problems. It should be understood that the electrical connector 100 according to the embodiments of the present disclosure may also be applied to other electrical components, which is not limited to the embodiments of the present disclosure.

Various embodiments of the present disclosure have been described above, which are exemplary, not exhaustive, and are not limited to the embodiments disclosed. Many modifications and variations will be apparent to those of ordinary skill in the art without departing from the scope and spirit of the illustrated embodiments. The selection of the terms used herein is intended to best explain the principles of the embodiments, practical applications, or technical improvements in the marketplace, or to enable others of ordinary skill in the art to understand the embodiments disclosed herein.

1. An electrical connector, comprising:
a pair of conductors;
a first insulating assembly disposed between the pair of conductors; and
a pair of second insulating assemblies each disposed on a side of the pair of conductors facing away from the first insulating assembly;
wherein each of the pair of conductors is integrally formed, or each of the pair of conductors comprises at least one pair of conductive parts.

2. The electrical connector according to claim 1, wherein each of the pair of conductors comprises a pair of conductive parts arranged along a first direction and detachably connected to each other.

3. The electrical connector according to claim 2, wherein surfaces of the pair of conductive parts adjacent to each other are planes.

4. The electrical connector according to claim 2, wherein each of the pair of conductive parts comprises grooves disposed on surfaces of the pair of conductive parts adjacent to each other.

5. The electrical connector according to claim 4, wherein the grooves of each of the pair of conductive parts are spaced apart from each other.

6. The electrical connector according to claim 5, wherein the grooves of each of the pair of conductive parts extend along a second direction perpendicular to the first direction.

7. The electrical connector according to claim 6, wherein the grooves in the pair of conductive parts are aligned with each other, or
the grooves in the pair of conductive parts are staggered from each other.

8. The electrical connector according to claim 1, wherein the at least one pair of conductive parts are arranged along a first direction, the electrical connector further comprises a pair of installation parts each disposed within an installation hole of a corresponding conductor, and along the first direction, one end of each of the pair of installation parts is matched with a corresponding first insulating assembly, and the other end of each of the pair of installation parts is matched with a corresponding second insulating assembly.

9. A DC busway, comprising:
an electrical connector, comprising:
a pair of conductors;
a first insulating assembly disposed between the pair of conductors; and
a pair of second insulating assemblies each disposed on a side of the pair of conductors facing away from the first insulating assembly;
wherein each of the pair of conductors is integrally formed, or each of the pair of conductors comprises at least one pair of conductive parts; and
a basic segment.

10. The DC busway according to claim 9, wherein each of the pair of conductors comprises a pair of conductive parts arranged along a first direction and detachably connected to each other.

11. The DC busway according to claim 10, wherein surfaces of the pair of conductive parts adjacent to each other are planes.

12. The DC busway according to claim 10, wherein each of the pair of conductive parts comprises grooves disposed on surfaces of the pair of conductive parts adjacent to each other.

13. The DC busway according to claim 12, wherein the grooves of each of the pair of conductive parts are spaced apart from each other.

14. The DC busway according to claim 13, wherein the grooves of each of the pair of conductive parts extend along a second direction perpendicular to the first direction.

15. The DC busway according to claim 14, wherein the grooves in the pair of conductive parts are aligned with each other, or
the grooves in the pair of conductive parts are staggered from each other.

16. The DC busway according to claim 9, wherein the at least one pair of conductive parts are arranged along a first direction, the electrical connector further comprises a pair of installation parts each disposed within an installation hole of a corresponding conductor, and along the first direction, one end of each of the pair of installation parts is matched with a corresponding first insulating assembly, and the other end of each of the pair of installation parts is matched with a corresponding second insulating assembly.
